(19) United States
(12) Patent Application Publication
(10) Pub. No.: US 2020/0096258 A1
(43) Pub. Date: Mar. 26, 2020

(54) HEATING MECHANISM AND APPARATUS

(71) Applicant: JOHN GONZALES, JBER, AK (US)

(72) Inventor: JOHN GONZALES, JBER, AK (US)

(21) Appl. No.: 16/137,825

(22) Filed: Sep. 21, 2018

(51) Int. Cl. F27D 5/00

(52) U.S. Cl. CPC F27D 5/00

(57) ABSTRACT

A heating mechanism that includes: heating elements; a heating apparatus, wherein the heating apparatus includes a clear lid and openings in the clear lid; burners beneath each of the openings; an ejection mechanism adapted to eject the heating elements placed in the burner; and a temperature control. The heating elements may be formed in the shape of rocks. Each burner preferably includes a grouping of jet flames.

### BACKGROUND OF THE INVENTION

### Field of Invention

The present invention relates to a heating mechanism and apparatus that heats portable heating elements for insertion into liquids and beverages.

### Description of Related Art

Individuals consume hot liquid beverages on a regular basis. Examples of hot liquid beverages include coffee, tea and even warm milk. Coffee may be prepared in a coffee maker and thus heated upon completion of brewing. However, some coffee may cool after a certain period of time once placed in an individual container, cup or mug. Further tea as well is prepared by placing of a tea bag or loose tea into warm water. The water for tea consumption may be prepared by using a teacup, a teapot or alternatively water may be warmed in a microwave. The microwave oven is commonly used to both reheat the hot beverages such as a coffee or for the initial heating of water for tea consumption. Further other beverages may be placed in a microwave for heating purposes. Some individuals avoid use of microwave ovens due to certain inherent hazards. As a result, it is advantageous to have an alternative means to heat beverages that are normally consumed in a warm state.

### SUMMARY OF THE INVENTION

The present invention relates to a heating mechanism that includes: heating elements; a heating apparatus, wherein the heating apparatus includes a clear lid and openings in the clear lid; burners beneath each of the openings; an ejection mechanism adapted to eject the heating elements placed in the burner; and a temperature control. The heating elements may be formed in the shape of rocks. Each burner preferably includes a grouping of jet flames.

### BRIEF DESCRIPTION OF DRAWINGS

FIG. 1 depicts a prospective view of a heating mechanism and apparatus according to the present invention.

### DETAILED DESCRIPTION

The present invention relates to a heating mechanism and apparatus that includes use of heating elements in form of rocks or stones that are placed within a burner, then are ejected and after ejection placed in a individual's liquid beverage. The heating elements or rocks are used as alternative means to heat liquid for consumption by a user. The rocks are portable and tongs are used to remove the heated rocks from the burner unit and then placed in a user's cup or mug.

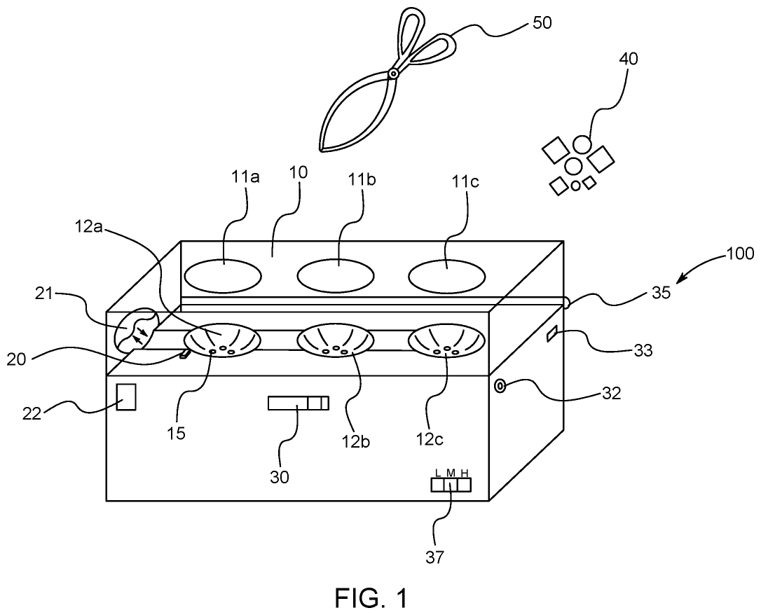

FIG. 1 depicts the heating mechanism and apparatus according to the present invention. The heating mechanism according to the present invention includes a heating apparatus 100. The heating apparatus 100 includes a clear lid 10, where the clear lid 10 includes a series of openings 11a, 11b, 11c. The openings 11a, 11b, 11c lie above burners 12a, 12b, 12c within the interior of the heating apparatus 100. The burners 12a, 12b, 12c include a series of openings that release flame burners. The heating elements 40 in the form of rocks are placed in the openings provided. Although shown as rocks or cubes, the heating elements 40 may be formed of various shapes suitable for placement in a cup or mug. Once placed in openings the burners may be turned to a on or heating position where jet burners 15 release heat to heat the elements within each cradle 12a, 12b, 12c.

An ejection button 22 is provided to eject the heating elements 40 once they have achieved the desired temperature through an ejection port 21. The ejection port 21 includes a pathway from the respective cradles for the transfer of the rocks into the port. A guide 20 is provided to ensure the pathway of the rocks through the port 21. A child safety lock is also provided on the heating mechanism 100. Other control features include a temperature control gauge 37, a power input 32 and a USB Port 33. The lid 10 lifts to open the position by use of a hinge 35 shown in FIG. 1. This transfer of the heating elements 40 through the heating process out the ejection port is conducive for use of the heating elements 40 in a beverage. The heating elements 40 may be removed by using tongs 50 to remove the heating elements and then place them in a beverage for consumption.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A heating mechanism comprising;
heating elements;
a heating apparatus, wherein the heating apparatus includes a clear lid and openings in the clear lid;
burners beneath each of the openings;
an ejection mechanism adapted to eject the heating elements placed in the burner; and
a temperature control.

2. The heating mechanism according to claim 1, where the heating elements are formed in the shape of rocks.

3. The heating mechanism according to claim 1, where each burner includes a grouping of jet flames.

4. The heating mechanism according to claim 1, where the ejection mechanism includes an ejection port.
